(19) United States
(12) Patent Application Publication
(10) Pub. No.: US 2013/0239988 A1
(43) Pub. Date: Sep. 19, 2013

(54) DEPOSITION CHAMBER CLEANING USING IN SITU ACTIVATION OF MOLECULAR FLUORINE

(71) Applicants: Jean-Charles Cigal, Bielefeld (DE); Ying-siang Hwang, Taoyuan (TW); Paul Alan Stockman, Hillsborough, NJ (US); Stefan Petri, Bielefeld (DE)

(72) Inventors: Jean-Charles Cigal, Bielefeld (DE); Ying-siang Hwang, Taoyuan (TW); Paul Alan Stockman, Hillsborough, NJ (US); Stefan Petri, Bielefeld (DE)

(21) Appl. No.: 13/701,959

(22) PCT Filed: Aug. 18, 2011
(86) PCT No.: PCT/US11/48227

§ 371 Date: May 31, 2013

Related U.S. Application Data
(60) Provisional application No. 61/376,780, filed on Aug. 25, 2010.

(51) Int. Cl. B08B 7/00

(52) U.S. Cl. CPC B08B 7/00
USPC 134/1; 118/715; 118/723 R

(57) ABSTRACT

Methods and apparatus for the cleaning reaction chambers using molecular fluorine as the cleaning material. The molecular fluorine is dissociated in-situ in the reaction chamber using the chamber RF power source.

### FIELD OF THE INVENTION

The present invention relates to new methods for the cleaning deposition chambers and to apparatus therefore.

### BACKGROUND OF THE INVENTION

Amorphous and microcrystalline thin films are used to fabricate photovoltaic devices and are generally deposited using chemical vapor deposition techniques; including plasma enhanced chemical vapor deposition (PECVD) methods. These processes deposit thin films from a gas state to a solid state onto the surface of a substrate by injecting precursor reacting gases into a reactor chamber and then activating the gases using a plasma created by radio frequency (RF) power. The manufacture of devices using chemical deposition methods include the depositing of thin films of silicon, silicon oxide, silicon nitride, metals oxides, and others. These deposition processes leave deposits in the chamber that must be periodically cleaned.

Known methods for cleaning reactor chambers include in-situ activation of a cleaning gas containing fluorine, such as NF₃, SF₆, C₂F₆, or other fluoro carbon molecules. The cleaning gas is introduced into the chamber and a plasma is ignited to create fluorine ions and radicals that react with silicon deposits on the sidewalls and parts of the chamber. However, the energy required to dissociate such fluorine containing molecules is high, therefore requiring an energy source in the chamber, such as RF power. This increases the risk of plasma induced damage to the chamber and equipment resulting in shortened lifetime of parts. Further, the fluorine containing gases have high global warming potentials causing detriment to the environment when the gases are not fully dissociated.

Another chamber cleaning method uses a remote plasma source to activate the fluorine containing cleaning gas. In this method, the cleaning gas first passes through a plasma source situated outside of the chamber where the cleaning gas is dissociated and radicals enter the chamber to perform the cleaning. Remote plasma activation can provide higher gas dissociation than in-situ activation and therefore improved cleaning efficiency. However, using a remote plasma source requires additional equipment that adds considerable to operations cost. Further, gas flow is often limited by the parameters of the remote plasma source thereby increasing cleaning time and cost. Moreover, remote plasma activation generally requires use of argon to start the plasma, because argon does not dissociate and is easily ignited. This use of argon reduces the gas flow of cleaning gas and therefore increases cleaning time cost. As noted, the fluorine containing cleaning gases have high global warming potentials causing detriment to the environment when the gases are not fully dissociated.

Other chamber cleaning methods include high temperature or high pressure cleaning. These methods require temperatures or pressures much higher than the temperatures used during deposition processes. Therefore, the temperature or pressure of the chamber must be adjusted prior to cleaning resulting in increased cleaning cycle time and greater cost of operation. Further, increased pressure cleaning may require additional pumping systems therefore adding equipment and operational costs. In addition, high pressure cleaning can lead to convection phenomena in the chamber which increases the risk of parts deformation.

There remains a need in the art for improvements to apparatus and methods for the cleaning reaction chambers.

### SUMMARY OF THE PRESENT INVENTION

The present invention provides improved methods and apparatus for the cleaning reaction chambers that overcome the disadvantages of the prior art methods and apparatus. In particular, the present invention utilizes molecular fluorine for cleaning of the chamber.

### BRIEF DESCRIPTION OF THE DRAWINGS

FIG. 1 is a graph showing the pressure curve during an in-situ activation cleaning process using molecular fluorine with no pressure regulation.

FIG. 2 is a graph showing the influence of RF power for in-situ activation cleaning of reaction chambers.

FIG. 3 is a graph showing the influence of fluorine flow rate on cleaning time of reaction chambers.

FIG. 4 is a graph showing the cleaning efficiency of the present invention.

FIG. 5 is a mass spectrometry result showing the cleaning efficiency of the present invention.

FIG. 6 is a graph comparing pressure stabilization in the chamber for remote plasma activation and in situ activation.

### DETAILED DESCRIPTION OF THE INVENTION

The present invention uses molecular fluorine for reaction chamber cleaning. The reaction chambers are used to deposit a variety of thin layers, including silicon (both amorphous and microcrystalline). For most depositions, plasma activation (either in-situ or remote) is necessary to dissociate the precursor materials and deposit the desired molecules onto the surface of a substrate. During deposition, material also accumulates on the walls and internal equipment surfaces of the reaction chamber. These deposits must be periodically removed by cleaning with a cleaning gas.

In accordance with the present invention, fluorine radicals created by dissociation of molecular fluorine have been shown to be very efficient as a cleaning gas. The dissociation energy required for molecular fluorine is relatively low and therefore can be carried out using the RF power source already in place within the reaction chamber, i.e. the RF power source used for dissociation of the deposition precursors. No remote plasma activation is necessary and therefore no additional equipment is needed beyond what is already in place in the reaction chamber. Further, the present invention can be carried out at relatively low pressures and RF energy. In addition, when using molecular fluorine, the addition of oxygen or argon for plasma ignition purposes is not necessary.

FIG. 1 is a graph showing the pressure curve during an in-situ activation cleaning process using molecular fluorine with no pressure regulation. As shown, when molecular fluorine has been introduced into the chamber, the pressure stabilizes at a certain pressure range, often referred to as the lower plateau. During this phase, known as the main clean, the silicon deposits throughout the chamber are etched by fluorine in the form of both radicals and molecules. Once the silicon has been removed from the larger parts of the chamber, e.g. the showerhead, a larger amount of fluorine remains in the chamber but has nothing left to react with. This leads to a sharp increase in pressure which rises to a second plateau during which time fluorine continues to react with silicon remaining in more remote areas of the chamber. When the last residual silicon has been removed, no further reaction occurs with the fluorine and the pressure stabilizes. This signals the end of the cleaning process and the gas line is then purged with an inert gas, such as argon.

By carrying out chamber cleaning using molecular fluorine and in situ activation in the chamber according to the present invention, many benefits are achieved. For example, F₂ has lower dissociation energy than NF₃ or SF₆ that allows for higher flow rates to be used while still achieving good dissociation rates and fast cleaning times. When using NF₃ or SF₆ a remote plasma source is necessary and the flow rate of fluorine into the chamber is therefore limited by the maximum power of the remote plasma source. Using molecular fluorine with in situ activation does not require a remote plasma source and therefore the desired higher flow rates can be used. This makes the process according to the present invention more economical as large, powerful and costly remote plasma sources are not needed.

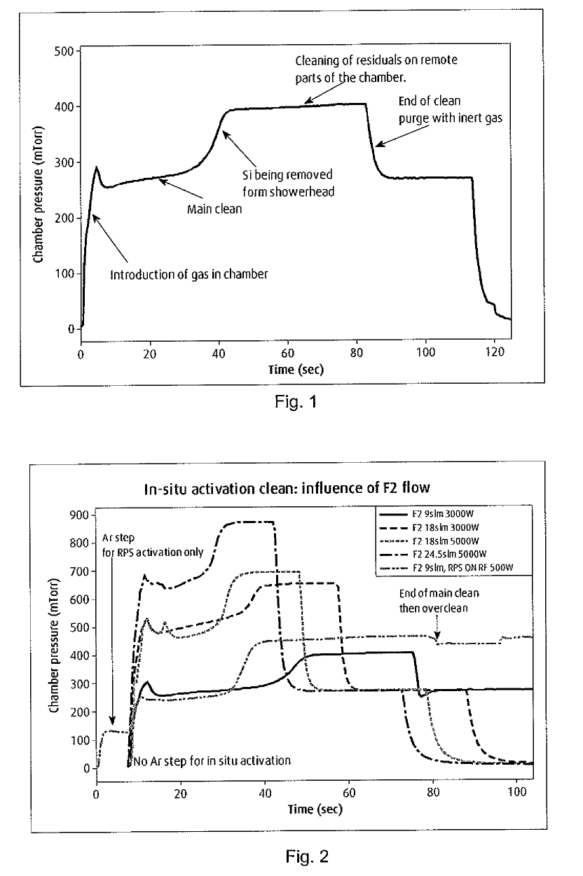

FIG. 2 is a graph showing the influence of RF power for in-situ activation cleaning of reaction chamber. In particular, FIG. 2 compares chamber cleaning results using molecular fluorine dissociated using the RF power source of the chamber in accordance with the present invention and chamber cleaning results using a remote plasma assisted cleaning with molecular fluorine, all at the same fluorine gas flow.

As shown in FIG. 2, for the same amount of fluorine provided to the chamber, the in-situ activation of the present invention provides for a faster overall cleaning time. The sharp increase in pressure of all of the cleaning plots indicates when silicon has been removed from the large portions of the chamber, e.g. the showerhead. While this occurs slightly faster for the remote plasma activation, the overall cleaning time is faster for the in situ process. Also as shown in FIG. 2, full dissociation of the molecular fluorine is not achieved when using the reactor chamber RF power source at 3000 W because of the lower pressure that is reached as compared to using a remote plasma source for the same gas flow rate. Using the reactor chamber RF power source at 5000 W achieves better dissociation of the molecular fluorine but does not provide faster cleaning times. However, in either case, the use of molecular fluorine with in situ activation according to the present invention results in faster overall cleaning times as noted.

The faster overall cleaning times achieved when using the reactor chamber RF source are at least in part attributed to not needing argon ignition as required by the remote plasma source. In addition, because of the lower pressure cleaning, the plasma expands to a greater extent within the reaction chamber resulting in better distribution of the fluorine ions throughout the chamber and consequently faster overall cleaning.

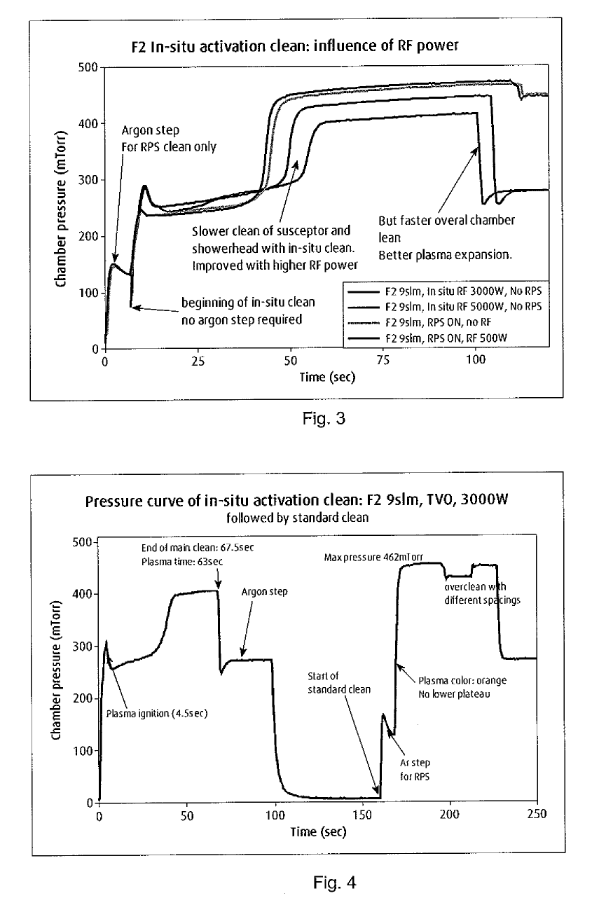

Even faster cleaning times may be achieved by increasing the molecular fluorine flow rate. FIG. 3 shows the effect of fluorine flow rate on cleaning time. In particular, good results were achieved by increasing fluorine flow rate while maintaining relatively low RF power (5000 W or less). By increasing the flow rate of fluorine into the chamber, a greater amount of fluorine is present in the chamber for cleaning purposes and therefore cleaning rates can be increased and cleaning times reduced. The results for flow rates of 9 slm, 18 slm and 24.5 slm are shown in FIG. 3 wherein it is clear that higher flow rates result in faster cleaning times. Further, as shown in FIG. 3, an increase in RF activation power may result in faster cleaning times, at least for a flow rate of 18 slm. The ability to run at higher flow rates while keeping power low is a decided advantage for the use of molecular fluorine over fluorine containing compounds. In particular, it is not generally possible to increase the flow rate of fluorine containing compounds, such as NF₃ of SF₆ because of their relatively high dissociation energies. Because of the relatively low dissociation energy of molecular fluorine, the higher flow rates are made possible with the consequent improvements to cleaning cycle times.

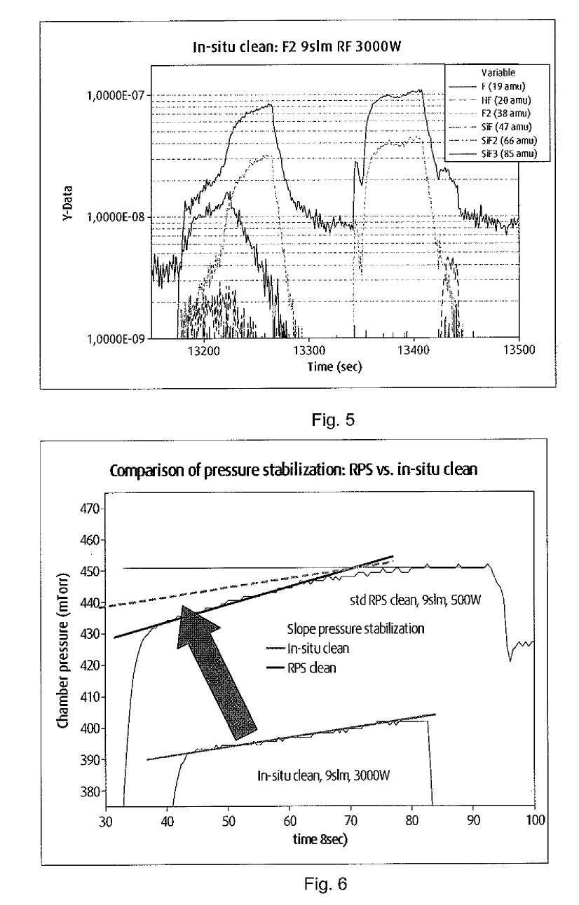

The cleaning efficiency of using in situ activation of molecular fluorine according to the present invention is shown in FIG. 4 and FIG. 5. In particular, FIG. 4 shows a plot of chamber pressure when an in situ activation according to the present invention is performed followed by a standard remote plasma source activation cleaning. As shown in FIG. 4, the in situ cleaning cycle shows the typical pressure graph with lower and second plateaus. Once this cleaning is complete, a standard remote plasma source cleaning cycle is begun and as shown in FIG. 4, the pressure immediately rises to the second plateau and stabilizes. This indicates that silicon has been efficiently removed from the chamber during the in situ activation cleaning process.

FIG. 5 again shows the efficiency of the present invention using mass spectrometry results. The same cleaning sequence was followed, i.e. in situ cleaning followed by remote plasma source cleaning. As shown in FIG. 5, no trace of silicon fluoride compounds are detected during the remote plasma source cleaning, indicating that the in situ activation cleaning efficiently removed the silicon from the chamber.

Using molecular fluorine according to the present invention is beneficial at least in part because it is an extremely reactive material. Therefore, molecular fluorine will react with silicon even without dissociation. In other words, using molecular fluorine provides the benefit that both dissociated fluorine and molecular fluorine participate in the cleaning process. Further, because molecular fluorine expands readily to remote parts of the chamber, the result is that large central portions of the chamber, e.g. the showerhead, as well as remote parts of the chamber, e.g. sidewalls, are cleaned simultaneously.

FIG. 6 is a graph comparing pressure stabilization in the chamber for remote plasma activation and in situ activation. This graph shows that during the upper plateau phase of the cleaning, i.e. once the main parts of the chamber have been cleaned of silicon, that the pressure varies significantly less for the in situ process than for the remote plasma source process. This indicates that most of the silicon has already been removed during the main cleaning phase of the in situ process, i.e. the remote portions of the chamber are cleaning simultaneously with the main portions. This results in the overall faster cleaning times achieved by the present invention.

The use of molecular fluorine in accordance with the present invention provides several advantages over the use of fluorine containing cleaning gases, such as NF₃ and SF₆. In particular, the dissociation of these fluorine containing gases requires much greater RF power and therefore if only the reactor chamber RF power source is used, there is a significant risk of plasma induced damage to the reactor, such as by arcing. Further, use of a remote plasma source is not required when using molecular fluorine according to the present invention. The fluorine containing compounds normally need such a remote plasma source to avoid the risk of plasma induced chamber damage and therefore require additional equipment that adds to operational complexity and cost. Moreover, the use of fluorine containing compounds often requires the addition of oxygen or argon as an aid to plasma ignition. When using molecular fluorine according to the present invention, the use of such additional gases, e.g. oxygen or argon, is not necessary.

The present invention using molecular fluorine overcomes the disadvantages of the prior art chamber cleaning methods. In particular, there is less limitation on the gas flow and chamber pressure. Lower RF power can be used resulting in less risk of plasma induced damage. Molecular fluorine has no global warming potential. Therefore, incomplete dissociation will not harm the environment nor require complex abatement systems. As noted, no additional equipment, such as a remote plasma source is necessary for the present invention and faster overall chamber cleaning times are achieved. Further, by using molecular fluorine, in-situ dissociation can be carried out at temperatures and pressures like those used for the deposition processes. Therefore, there is no time lost for adjusting and re-establishing temperature and pressure conditions as would be necessary for the high temperature and high pressure methods of the prior art.

Importantly, the present invention provides complete cleaning of the chamber in significantly less time than required when using a remote plasma source.

The above discussion of the present invention focuses on the use of molecular fluorine for reactor chamber cleaning. However, the present invention may also be useful for cleaning of silicon coated materials or for cleaning silicon containing materials such as silicon oxides, silicon nitrides, silicon oxy-nitrides, silicon carbides, silicon carbonitrides, etc.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A method of cleaning a chemical vapor deposition chamber comprising:
introducing molecular fluorine into the chamber;
at least partially dissociating the molecular fluorine in situ with in the chamber to form fluorine radicals;
allowing the fluorine radicals and molecular fluorine to react with unwanted deposits in the chamber; and
evacuating the chamber.

2. The method according to claim 1 wherein the chamber is a plasma enhanced chemical vapor deposition chamber.

3. The method according to claim 1 wherein dissociating the molecular fluorine comprises exposing the molecular fluorine to an RF power source of 3000 W to 5000 W.

4. The method according to claim 1 wherein dissociating the molecular fluorine comprises exposing the molecular fluorine to an RF power source of about 3000 W.

5. The method according to claim 1 wherein introducing fluorine comprises introducing fluorine at a flow rate between 9 slm and 24.5 slm.

6. The method according to claim 5 wherein the flow rate is about 18 slm.

7. An apparatus for cleaning a chemical vapor deposition chamber comprising:
a deposition chamber with a power source located therein; and
a source of molecular fluorine connected to the deposition chamber.

8. The apparatus of claim 7 wherein the chamber is a plasma enhanced chemical vapor deposition chamber.

9. The apparatus of claim 7 wherein the power source is an RF power source.
